(19) United States
(12) Patent Application Publication
(10) Pub. No.: US 2012/0289409 A1
(43) Pub. Date: Nov. 15, 2012

(54) Species Specific Nucleotide (SSN) Sequences as a Rapid Diagnostic

(75) Inventors: George Pieczenik, Stockton, NJ (US); Errol Berman, (US); Carole P. McArthur, Kansas City, MO (US); Jane Pierce-Pieczenik, (US)

(73) Assignee: George Pieczenik, Stockton, NJ (US)

(21) Appl. No.: 13/436,971

(22) Filed: Apr. 1, 2012

(51) Int. Cl. C40B 20/00; C40B 40/06; C40B 50/02

(52) U.S. Cl. 506/2; 506/24; 506/16

(57) ABSTRACT

A data base of species specific nucleotide sequences (SSN) is created. The chemically synthesized sequences are used as DNA sequencing primers. Different mixes of DNA primers allow for the rapid and unique identification of any pathogen previously identified in the species specific data base.

Staphylococcus simulans can be identified as the causative agent of Interstitial Cystitis using the unique SSN sequence 5′ ATG GAT GTT TCA AAA AAA GTA GCT 3′ coding for pre-prolysostaphin using it as a differential DNA primer in a mix set of pathogenic SSN sequence primers.

Many genomic sequences of microbiological organisms have been completed. This large data set allows one to look for nucleotide sequences that are characteristic of each species of completely sequenced microbiological organism and other organisms. Some species also carry unique sequences that are carried by plasmids and extra-chromosomal sequences.

One example is Staphylococcus simulans which carries a plasmid with a beta-lactamase gene and, also, for a gene for lysostaphin, a protease which cleaves the poly-glycine glycans cross-links in membranes of other Staphylococcus species, such as Staphylococcus aureus.

The reference “Cloning, sequence, and expression of the lysostaphin gene from Staphylococcus simulans” Proc. Nati. Acad. Sci. USA, Vol. 84, pp. 1127-1131, March 1987, by PAULA. RECSEI*, ALEXANDRA D. GRUSS, AND RICHARD P. NOVICK is incorporated by reference.

Identifying one SSN sequence in Staphylococcus simulans.

The complete sequence of the lysostaphin gene is unique to the species Staphylococcus simulans. Therefore, every sufficiently long subset of this sequence is unique to this Staphylococcus species.

For example, a sequence that is 24 nucleotides long would be expected to occur once in about 3×10̂14 nucleotide sequences. Therefore, it probably can found only once in the total genomic data base for bacteria where about 78 common pathogenic genomes have been completed.

This data base and those of protests, fungi and metazoans are incorporated by reference,

http://bacteria.ensembl.org/info/about/species.html,

http://protists.ensembl.org/index.html,

http://fungi.ensembl.org/index.html,

http://metazoa.ensembl.org/index.html,

the human genome data base and the total BLAST data base.

Determining Unique SSN Sequence Lengths:

One would expect that a sequence that is anywhere from 18-24 nucleotide sequences, to be called “species specific nucleotide sequence” or SSN sequences, can be found that is unique to each virus, bacteriophage, bacterial, protest, fungal, animal, plant and human sequences.

Each identified SSN sequence can then be run through a BLAST search to demonstrate that that SSN sequence is unique to that organism. This method can be used to identify a priori all possible SSN sequences and to have them checked a posteriori as to their uniqueness.

Chemical Synthesis of SSN Sequences:

The optimal size for sequencing primers is somewhere between 18-24 nucleotides, but can be in the range of 15 to 30 nucleotides. This is also the nucleotide size range for SSN sequences. Therefore, SSN sequences are also optimal primers for a DNA sequencing reactions. Therefore, chemically synthesizing the uniquely identified SSN sequences creates unique DNA sequencing primers.

The method of chemically synthesizing DNA from a known DNA sequence is known in the art. The following literature describing the known are is incorporated, herein, by reference, see Brown, Dan, “A brief history of oligonucleotide synthesis” Methods in Molecular Biology (US) (1993), 20 (Protocols for Oligonucleotides and Analogs), 1-17. Also, DNA primers can be synthesized cheaply and are commercially available (Genesript, Genewiz, IDT, inter alia).

These chemically synthesized SSN sequences can be used to identify any clinical sample that has been plated and grows as a bacterial or viral colony.

A four hour method of DNA amplification at one temperature uses Phi29 DNA polymerase which amplifies by strand displacement. (GE Healthcare's The illustra™ GenomiPhi™ HY DNA Amplification Kit).

The product protocol is very simple, and provides typical yields of 40 to 50 μg DNA and average product lengths >10 kb. The starting material for GenomiPhi reactions can be purified DNA, nonpurified cell lysates or cell colonies.

Genewiz™ routinely amplifies DNA sequences of bacterial and bacteriophage colonies, using this GenomiPhi kits and then sequencing the DNA using the ABI automated DNA sequencer and reaction mixes, with primers provided by the requesting investigator. The normal runs of sequence run to about 700 nucleotides. This rapid DNA amplification and subsequent sequencing methods using chemically synthesized DNA primers in the size of these SSN sequences are incorporated, herein, by reference.

Therefore, a kit, containing from about 1 to 1000 SSN sequences, (or a kit with an average number of SSN sequences being about 20 to 80 for the more common pathogens) could be used to prime a sequencing reaction in an unknown bacteria or virus (organism) infected bacteria. Only the primer in the SSN kit that hybridizes to the unknown bacteria, virus or organism's DNA will prime the DNA sequencing reaction. The sequence then can be analyzed to identify the unique species of virus, bacteria or organism identified.

For example, the unique primer for the Staphylococcus simulans that differs it from Staphylococcus aureus would be the sequence 5′ ATG GAT GTT TCA AAA AAA GTA GCT 3′ , the ATG corresponding to the 102nd MET amino acid in the preprolysostaphin coding (SSN sequence for Staphylococcus simulans). This SSN for Staphylococcus simulans would uniquely prime the DNA plasmid in the Staphylococcus simulans and generate the unique nucleotide sequence for Staphylococcus Simulans pre-prolysostaphin protein coding. Any other added primers that were not this SSN sequence would not prime nor generate a readable DNA sequence.

Identifying Staphylococcus Simulans as the Causative Agent of Interstitial Cystitis

Interstitial Cystitis is a disease of unknown etiology. It is a debilitating disease where the bladder lining is denuded by a sialoglycopeptide that has an antiproliferation function (APP). Its sequence is Thr-Val-Pro-Ala-Ala-Val-Val-Val-Ala. This peptide is a cleavage product from a Frizzled 8 Wnt ligand receptor and glycosylated. The following reference is incorporated, herein. “An antiproliferative factor from interstitial cystitis patients is a frizzled 8 protein-related sialoglycopeptide” (PNAS, Aug. 10, 2004, vol. 101, no. 32, pgs. 11803-11808) Susan Keay et. al.)

Staphylococcus simulans was identified in an IC patient's (JPP) urine after culturing for 7 days at 37 degrees on LB plates, through conventional sensitivity tests and stains. It can, also, be identified by using the SSN sequence for Staphylococcus simulans as a primer after amplifying the Staphylococcus simulans DNA using the methods described above in Para 19 through 24.

The other postulated proteases and glycosidases excreted by Staphylococcus simulans, similar to the lysostaphilin protease, can possibly explain the cleavage of APP peptide from the Frizzled 8, Wnt receptor protein, thereby inhibiting proliferation of bladder cell lining and causing the Interstitial Cystitis syndrome and resultant pain. The slow growth of Staphylococcus simulans can also explain the difficulty in conventional microbiological plate testing to have failed to detect this causative agent.

The SSN Sequence Data Base:

In addition, one can generate a data base containing all the SSN sequences for all species. This data base would be useful to identify making sets of SSN nucleotide primers for different kits for subsets of different possible microbial infection candidates, which need to be identified rapidly. Using SSN primers for sequencing as an identification method would allow identification within 5 hours after the clinical and unknown colonies have been grown. This would be a unique and extremely useful tool in treating emergency cases of sepsis and infection. The infection organism can be identified within 5 hrs, the appropriate antibiotic sensitivity can be identified from the literature and the most appropriate treatment administered readily. Kits of chemically synthesized SSN sequences containing groupings of different suspected pathogenic organisms, in order to make a differential diagnoses, can made readily available using this invention's data base and method of identification. For example, Staphylococcus simulans can be identified as the causative agent of Interstitial Cystitis using the unique SSN sequence 5′ ATG GAT GTT TCA AAA AAA GTA GCT 3′ coding for pre-prolysostaphin using it as a differential DNA primer in a mix set (one hundred for example) pathogenic SSN sequence primers, inter alia.

What is claimed is:

1. A data base of species specific nucleotide sequences (SSN sequences).

2. The data base of SSN sequences of claim 1, where the data base contains SSN sequences of about five to ten triplet in length or about 15 to 30 nucleotides long.

3. The data base of SSN sequences of claim 2 where the data base contains SSN nucleotide sequences of about 18 to 24 nucleotides long.

4. The SSN sequences of claim 2 where the chemically synthesized SSN nucleotide sequences are used as DNA sequencing primers.

5. The SSN sequences of claim 3 where the synthesized SSN nucleotide sequences are used as DNA sequencing primers.

6. The data base SSN sequence of claim 3 where the 5′ ATG GAT GTT TCA AAA AAA GTA GCT 3′ nucleotide sequence is 24 long and identifies Staphylococcus simulans uniquely.

7. The chemically synthesized SSN sequence of claim 6, where 5′ ATG GAT GTT TCA AAA AAA GTA GCT 3′ is used as a DNA sequencing primer.

8. The method of compiling a species specific nucleotide (SSN) sequence data base comprising the steps of:
a) identifying sequences in the range of 15 to 30 nucleotides that exist only in a given species and none other; and,
b) doing a BLAST search of that sequence of all known species nucleotide sequences; and,
c) demonstrating that the BLAST searched SSN sequence is unique to each species; and,
d) compiling all the unique SSN sequences into a species specific nucleotide (SSN) sequence data base.

9. The method of using a SSN sequence and sets of SSN sequences identified in the compiled SSN sequence data base of claim 8 as DNA sequencing primers to identify an unknown organism comprising the steps of:
a) identifying the SSN and set of SSN to be used for identification of unknown organism; and,
b) amplifying DNA from said unknown organism using GenomiPhi kits; and,
c) synthesizing chemically said identified SSN and set of SSN sequences as DNA primers; and,:
d) mixing said chemically synthesized SSN primer and set of SSN primers to prime the DNA sequencing of said amplified DNA from said unknown organism; and,
e) DNA sequencing of said mix of chemically synthesized SSN primer and set of SSN primers to prime the sequencing of said amplified DNA from said unknown organism; and,
f) doing a BLAST search of the DNA sequence identified from having DNA sequenced the mix of chemically synthesized SSN primer and set of SSN primers and amplified DNA from said unknown organism, and
g) identifying said unknown organism from said BLAST search of said sequenced DNA from said unknown organism.

10. The method of identifying Staphylococcus simulans as the causative agent for Interstitial Cystitis comprising the steps of
a) identifying the SSN sequence 5′ ATG GAT GTT TCA AAA AAA GTA GCT3′ for Staphylococcus simulans; and,
b) amplifying DNA from said unknown organism using GenomiPhi kits; and,
c) synthesizing chemically said identified Staphylococcus simulans SSN sequence 5′ ATG GAT GTT TCA AAA AAA GTA GCT 3′ as a DNA primer; and,:
d) mixing said chemically synthesized Staphylococcus simulans SSN primer 5′ ATG GAT GTT TCA AAA AAA GTA GCT 3′ nucleotide sequence to prime the DNA sequencing of said amplified DNA from said unknown organism; and,
e) DNA sequencing of said mix of chemically synthesized Staphylococcus simulans SSN primer 5′ ATG GAT GTT TCA AAA AAA GTA GCT 3′ nucleotide sequence to prime the sequencing of said amplified DNA from said unknown organism; and,
f) doing a BLAST search of the DNA sequence identified from having DNA sequenced from the mix of chemically synthesized Staphylococcus simulans SSN primer 5′ ATG GAT GTT TCA AAA AAA GTA GCT 3′ and amplified DNA from said unknown organism; and,
g) identifying said unknown organism from said BLAST search of said sequenced DNA from said unknown organism as Staphylococcus simulans.

11. A kit comprising chemically synthesized SSN sequences for a mixed set of different groupings of pathogenic organisms for a differential identification of a specific member.


SEQUENCE LISTING (2 sequences)

SEQ ID NO: 1 - DNA, 24 bp, Staphylococcus simulans
atggatgtttcaaaaaaagtagct

SEQ ID NO: 2 - protein, 9 aa, Human <s300> Keay, S. et. al. An antiproliferative factor from interstitial cystitis patients is a frizzled 8 protein-related sialoglycopeptide Proceedings of the National Academy of Science 101 32 11803-11808 2004-08-10
TVPAAVVVA